(19) United States
(12) Patent Application Publication
(10) Pub. No.: US 2017/0089941 A1
(43) Pub. Date: Mar. 30, 2017

(54) SENSOR

(71) Applicant: Panasonic Intellectual Property Management Co., Ltd., Osaka (JP)

(72) Inventors: TAKASHI IMANAKA, Osaka (JP); TAKANORI AOYAGI, Osaka (JP); TAKAMI ISHIDA, Osaka (JP); HIROYUKI AIZAWA, Fukui (JP)

(21) Appl. No.: 15/128,096

(22) PCT Filed: Apr. 7, 2015
(86) PCT No.: PCT/JP2015/001943

§ 371 Date: Sep. 21, 2016

(30) Foreign Application Priority Data
Apr. 8, 2014 (JP) 2014-079113
Jun. 27, 2014 (JP) 2014-132235

(51) Int. Cl. G01P 15/08; G01P 15/18

(52) U.S. Cl. CPC G01P 15/08; G01P 15/18

(57) ABSTRACT

A sensor includes an upper lid layer, a lower lid layer, and a sensor layer disposed between the upper lid layer and the lower lid layer. One of the upper lid layer and the lower lid layer includes an insulative region mainly made of glass, a via-electrode covered with the insulative region, and an outer circumferential region mainly made of silicon and provided at an outer circumference of the insulative region. This sensor allows reducing outer dimensions of a wafer, which is a material for the sensor.

### TECHNICAL FIELD

The present invention relates to a sensor to be mounted to, for instance, a vehicle or a portable phone. This sensor senses inertial force, such as acceleration.

### BACKGROUND ART

FIG. 19 is a plan view of conventional sensor 400 disclosed in PTL 1. FIG. 20 is a sectional view cut of sensor 400 on line XX-XX shown in FIG. 19. Upper lid electrodes 52a and 52b are formed on a lower surface of upper lid layer 51 made of glass. Upper lid electrode pads 53 are formed on an upper surface of upper lid layer 51. Upper lid electrode pads 53 are electrically connected to electrodes 52 fixed to the upper lid via lead-wires 55 provided in through-holes 54 passing through the upper lid.

Lower lid electrodes 57a and 57b are provided on an upper surface of lower lid layer 56 made of glass. Lower lid electrode pads 58 are provided on a lower surface of lower lid layer 56. Lower lid electrode pads 58 are electrically connected to electrodes 57 on the lower lid layer 56 via lead-wires 60 provided in through-holes 59 passing thorough lower lid layer 56. Sensor layer 61 made of silicon has outer frame 62. Outer frame 62 is bonded between the lower surface of upper lid layer 51 and the upper surface of lower lid layer 56.

Sensor layer 61 includes beam 63 having a beam shape. One end of beam section 63 is connected to outer frame 62 while another end thereof is provided with movable electrode 64.

An operation of conventional sensor 400 with described below with reference to drawings.

FIG. 21 is a sectional view of sensor 400 in which movable electrode 64 having an attitude changed. An acceleration applied to movable electrode 64 in first sensing axis (x-axis) causes movable electrode 64 to angle with respect to the X-axis, and then, changes a distance between movable electrode 64 and each of upper-lid fixed electrodes 52a and 52b and lower-lid fixed electrodes 54a and 57b. To be more specific, the acceleration decreases the distance between upper-lid fixed electrode 52a and movable electrode 64, and the distance between lower-lid fixed electrode 57b and movable electrode 64 while increasing the distance between upper-lid fixed electrode 52b and movable electrode 64 and the distance between lower-lid fixed electrode 57a and movable electrode 64. Such changes in the distances between the electrodes exhibit changes in electrostatic capacitances between the electrodes. The change in the attitude of movable electrode 64 can be thus sensed based on a change in the capacitance by processing output signals from upper-lid electrode pad 53 and lower-lid electrode pad 58.

Another conventional sensor can be manufactured by placing an upper-lid wafer on a sensor element wafer, and dicing the resultant layer to be divided. Conventional sensors similar to this sensor are disclosed in, for instance, PTL 2.

### CITATION LIST

### Patent Literature

PTL 1: Japanese Patent Laid-Open Publication No. 2008-196883
PTL 2: Japanese Patent No. 5231165

### SUMMARY

A sensor includes an upper lid layer, a lower lid layer, and a sensor layer disposed between the upper lid layer and the lower lid layer. One of the upper lid layer and the lower lid layer includes an insulative region mainly made of glass, a via-electrode covered with the insulative region, and a circumferential region mainly made of silicon and provided at an outer circumference of the insulative region. This sensor allows reducing outer dimensions of a wafer, which is a material for the sensor.

### BRIEF DESCRIPTION OF DRAWINGS

FIG. 1 is a perspective view of a sensor device in accordance with Exemplary Embodiment 1.

FIG. 2A is a perspective view of a sensor in accordance with Embodiment 1.

FIG. 2B is an exploded perspective view of the sensor in accordance with Embodiment 1.

FIG. 3 is a sectional view of the sensor along line shown in FIG. 2A.

FIG. 4 is a sectional view of the sensor along line IV-IV shown in FIG. 2A.

FIG. 5 is a sectional view of the sensor in accordance with Embodiment 1 for illustrating an operation of the sensor having no acceleration along an X-axis applied thereto.

FIG. 6 is a schematic view of the sensor in accordance with Embodiment 1 for illustrating an operation of the sensor having no acceleration along an X-axis applied thereto.

FIG. 7 is a sectional view of the sensor in accordance with Embodiment 1 for illustrating an operation of the sensor having an acceleration along the X-axis applied thereto.

FIG. 8 is a schematic view of the sensor in accordance with Embodiment 1 for illustrating an operation of the sensor having an acceleration along the X-axis applied thereto.

FIG. 9 is a sectional view of the sensor in accordance with Embodiment 1 having an acceleration along a Z-axis Z applied thereto.

FIG. 10 is a schematic view of the sensor in accordance with Embodiment 1 for illustrating an operation of the sensor having an acceleration along the X-axis applied thereto.

FIG. 11A is a sectional view of the sensor in accordance with Embodiment 1 for illustrating a method of manufacturing the sensor.

FIG. 11B is a sectional view of the sensor in accordance with Embodiment 1 for illustrating the method of manufacturing the sensor.

FIG. 11C is a sectional view of the sensor in accordance with Embodiment 1 for illustrating the method of manufacturing the sensor.

FIG. 11D is a sectional view of the sensor in accordance with Embodiment 1 for illustrating the method of manufacturing the sensor.

FIG. 11E is a sectional view of the sensor in accordance with Embodiment 1 for illustrating the method of manufacturing the sensor.

FIG. 11F is a sectional view of the sensor in accordance with Embodiment 1 for illustrating the method of manufacturing the sensor.

FIG. 11G is a sectional view of the sensor in accordance with Embodiment 1 for illustrating the method of manufacturing the sensor.

FIG. 12 is a sectional view of the sensor in accordance with Embodiment 1 for illustrating another method for manufacturing the sensor.

FIG. 13A is a perspective view of a sensor in accordance with Exemplary Embodiment 2.

FIG. 13B is an exploded perspective view of the sensor in accordance with Embodiment 2.

FIG. 14 is a plan view of a sensing element of the sensor in accordance with Embodiment 2.

FIG. 15A is a sectional view of the sensor in accordance with Embodiment 2 for illustrating a method for manufacturing the sensor.

FIG. 15B is a sectional view of the sensor in accordance with Embodiment 2 for illustrating the method for manufacturing the sensor.

FIG. 15C is a sectional view of the sensor in accordance with Embodiment 2 for illustrating the method for manufacturing the sensor.

FIG. 15D is a sectional view of the sensor in accordance with Embodiment 2 for illustrating the method for manufacturing the sensor.

FIG. 16 is a sectional view of the sensor in accordance with Embodiment 2 2 for illustrating a process for manufacturing the sensor.

FIG. 17 is a sectional view of the sensing element along line XVII-XVII shown in FIG. 14.

FIG. 18 is an enlarge sectional view of the sensor in accordance with the second embodiment.

FIG. 19 is a plan view of a conventional sensor.

FIG. 20 is a sectional view of the sensor along line XX-XX shown in FIG. 19.

FIG. 21 is a sectional view of the conventional sensor for illustrating an operation of the sensor.

### DETAIL DESCRIPTION OF PREFERRED EMBODIMENTS

### Exemplary Embodiment 1

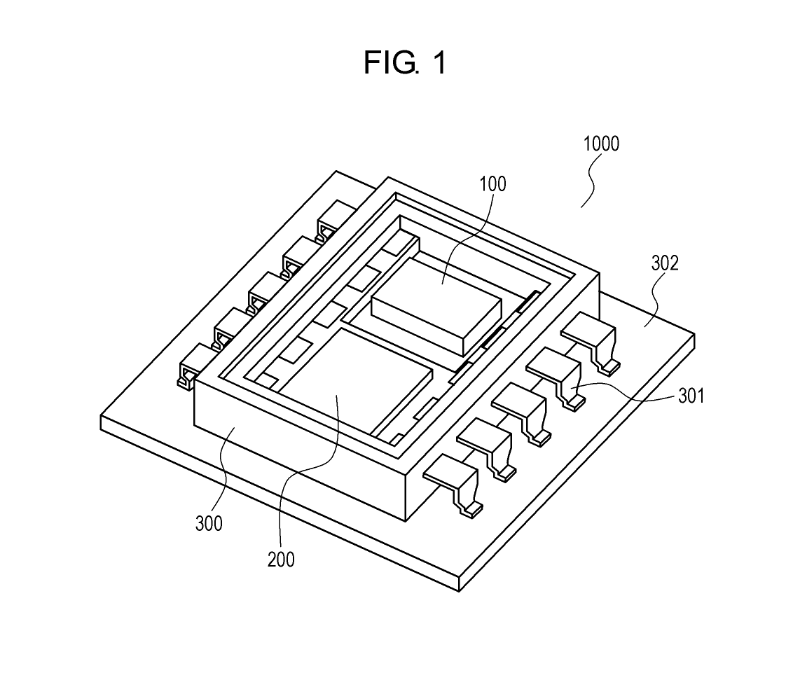

FIG. 1 is a perspective view of sensor device 1000 in accordance with Exemplary Embodiment 1 having an upper lid of sensor device 1000 removed. Sensor device 1000 includes package 300, sensor 100 mounted to package 300, processor 200 mounted to package 300, and terminals 301 led out from package 300. Processor 200 executes various calculations based on outputs from sensor 100. Terminals 301 led out from package 300 are connected to substrate 302.

### (Structure of Sensor 100)

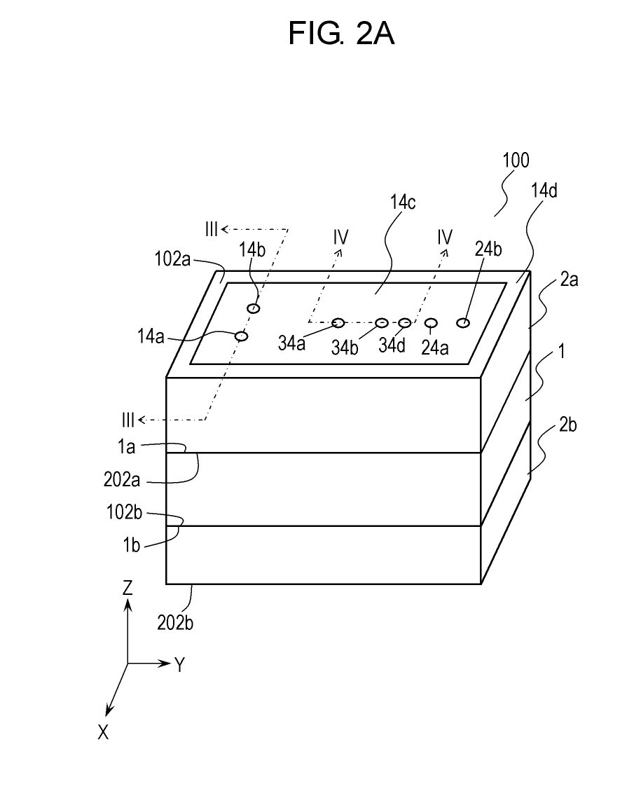

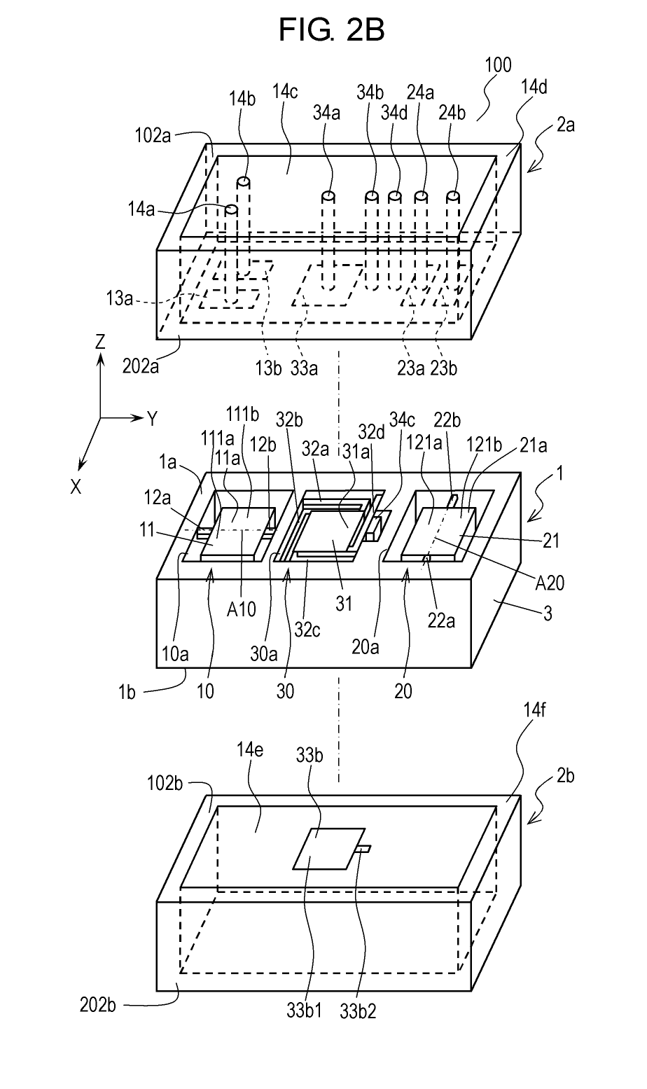

FIG. 2A and FIG. 2B are a perspective view and an exploded perspective view of sensor 100, respectively. In sensor 100, three weights are disposed in a single chip for sensing accelerations along three axes (i.e. an X-axis, a Y-axis, and a Z-axis). An acceleration along plane directions, i.e., XY directions including the X-axis and the Y-axis, can be sensed by moving a movable electrode (i.e. a weight) like a seesaw on a pair of twisted beams functioning as a shaft. An acceleration in a vertical direction, i.e., a direction of the Z-axis can be sensed by moving a movable electrode (i.e. weight) held by at least two beams along a vertical direction.

To be more specific, as shown in FIG. 2A and FIG. 2B, sensor 100 includes sensor layer 1, upper lid layer 2a disposed on upper surface 1a of sensor layer 1, and lower lid layer 2b disposed on lower surface 1b of sensor layer 1. Sensor layer 1 is made of a substrate made of SiSOI. Upper lid layer 2a and lower lid layer 2b are made of silicon (Si) and insulative material, such as glass.

Sensor layer 1 includes X-sensing section 10 for sensing an acceleration in a direction of the X-axis, Y-sensing section 20 for sensing an acceleration in a direction of the Y-axis, and Z-sensing section 30 for sensing an acceleration in a direction of the Z-axis. The direction of the X-axis is one of the plane directions. The direction of the Y-axis is one of the plane directions and is perpendicular to the X-axis. The direction of the Z-axis is a vertical direction. In sensor 100 in accordance with Embodiment 1, X-sensing section 10, Z-sensing section 30, and Y-sensing section 20 are arranged in a direction of the Y-axis such that Z-sensing section 30 is disposed between X-sensing section 10 and Y-sensing section 20. Upper surface 1a and lower surface 1b of sensor layer 1 extend in the plane directions. Upper lid layer 2a, sensor layer 1, and lower lid layer 2b are arranged in a direction of the Z-axis. Sensor layer 1 includes movable electrodes 11, 21, and 31 and frame 3 surrounding movable electrodes 11, 21, and 31. In accordance with Embodiment 1, frame 3 completely surrounds movable electrodes 11, 21, and 31 in the XY directions.

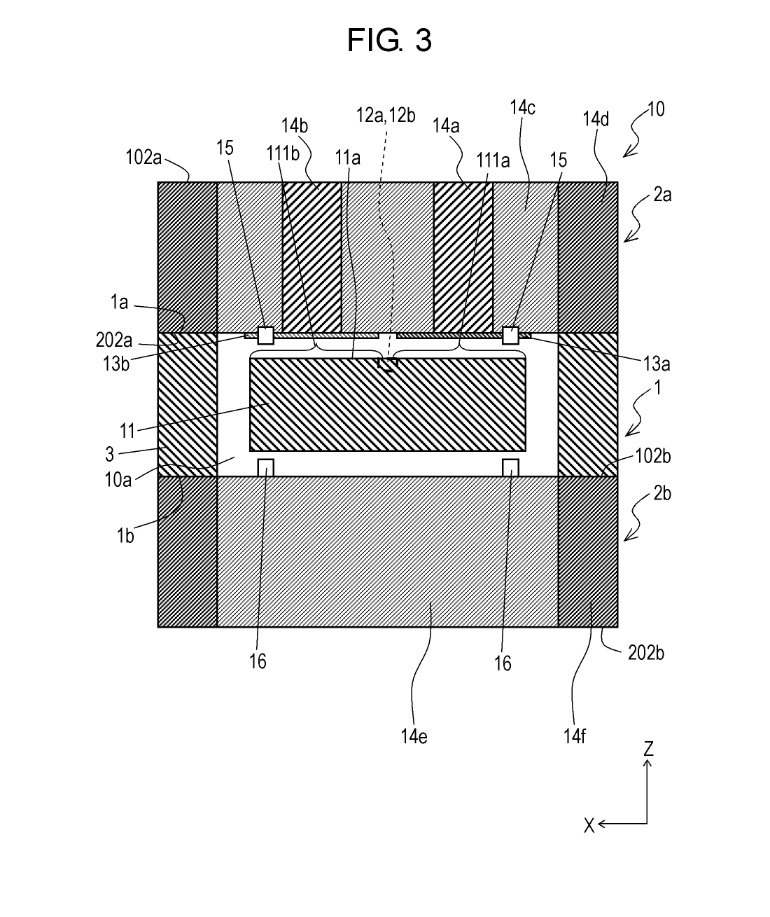

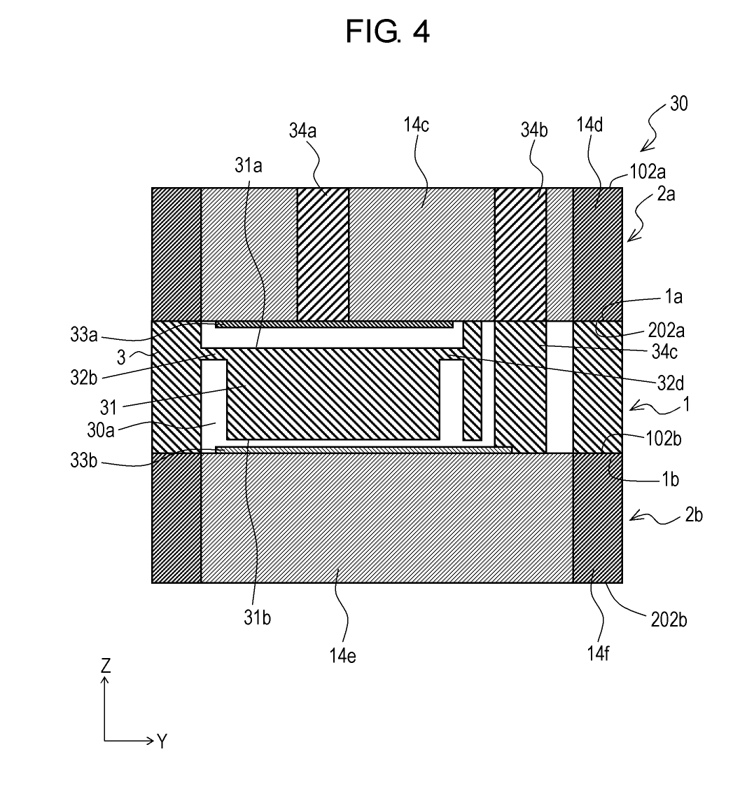

FIG. 3 is a sectional view of sensor 100 along line shown in FIG. 2A, and particularly illustrates a cross section of X-sensing section 10. FIG. 4 is a sectional view of sensor 100 along line IV-IV shown in FIG. 2A, and particularly illustrates a cross section of Z-sensing section 30. Y-sensing section 20 has a cross section similar to that of X-sensing section 10.

X-sensing section 10 has a shape identical to the shape of Y-sensing section 20 rotating by 90 degrees. X-sensing section 10 and Y-sensing section 20 are disposed at both sides of Z-sensing section 30 having a shape different from the shapes of X-sensing section 10 and Y-sensing section 20. X-sensing section 10, Y-sensing section 20, and Z-sensing section 30 are provided in a single chip. In other words, as shown in FIG. 2B, three rectangular frames 10a, 20a, and 30a are linearly arranged in a direction of the Y-axis in frame 3. Movable electrode 11 is placed in rectangular frame 10a, movable electrode 21 is placed in rectangular frame 20a, and movable electrode 31 is placed in rectangular frame 30a. Each of movable electrodes 11, 21, and 31 has substantially a rectangular shape. Movable electrodes 11, 21, and 31 are apart from side walls of rectangular frames 10a, 20a, and 30a by predetermined distances, respectively.

Sensor layer 1 further includes beams 12a and 12b constituting X-sensing section 10. In X-sensing section 10, movable electrode 11 swings about beams 12a and 12b as an axis, thereby sensing an acceleration in a direction of the X-axis. Beams 12a and 12b extend along rotation axis A10 extending in a direction of the Y-axis. Beam 12a is opposite to beam 12b with respect to movable electrode 11. Beams 12a and 12b connect movable electrode 11 to frame 3, such that movable electrode 11 can swing about rotation axis A10. Upper surface 11a of movable electrode 11 includes region 111a and region 111b divided by rotation axis A10 between beam 12a and beam 12b as a boundary line. Sensor 100 further includes fixed electrodes 13a and 13b facing regions 111a and 111b of upper surface 11a respectively. Fixed electrodes 13a and 13b are disposed on lower surface 202a of upper lid layer 2a. The acceleration in the direction of the X-axis can be sensed based on a change in a capacitance between movable electrode 11 and fixed electrode 13a, and based on a change in a capacitance between movable electrode 11 and fixed electrode 13b.

Sensor layer 1 further includes beams 22a and 22b constituting Y-sensing section 20. In Y-sensing section 20, movable electrode 21 swings about beams 22a and 22b as an axis, thereby sensing an acceleration in a direction of the Y-axis. Beams 22a and 22b extend in rotation axis A20 extending in a direction of the X-axis. Beam 22a is opposite to beam 22b with respect to movable electrode 21. Beams 22a and 22b connect movable electrode 21 to frame 3 such that movable electrode 21 can swing about rotation axis A20. Upper surface 21a of movable electrode 21 includes regions 121a and 121b divided by rotation axis A20 between beam 12a and beam 12b as a boundary line. Sensor 100 further includes fixed electrodes 23a and 23b facing regions 121a and 121b of upper surface 12a, respectively. Fixed electrodes 23a and 23b are disposed on lower surface 202a of upper lid layer 2a. The acceleration in the direction of the Y-axis direction can be sensed based on a change in a capacitance between movable electrode 21 and fixed electrode 23a, and based on a change in a capacitance between movable electrode 21 and fixed electrode 23b.

Sensor layer 1 further includes beams 32a, 32b, 32c, and 32d constituting Z-sensing section 30. In Z-sensing section 30, movable electrode 31 supported by beams 32a, 32b, 32C, and 32d moves in the vertical direction i.e. a direction of the Z-axis, thereby sensing an acceleration in a direction of the Z-axis direction. Beams 32a and 32c and movable electrode 31 are arranged in a direction of the X-axis. Beam 32a is opposite to beam 32c with respect to movable electrode 31. Beams 32b and 32d and movable electrode 31 are arranged disposed in a direction of the Y-axis. Beam 32b is opposite to beam 32d with respect to movable electrode 31. Beams 32a, 32b, 32c, and 32d connect movable electrode 31 to frame 3 such that movable electrode 31 can move in a direction of the Z-axis. Sensor 100 further includes fixed electrodes 33a and 33b disposed on lower surface 202a of upper lid layer 2a and upper surface 102b of lower lid layer 2b. The acceleration in the direction of the Z-axis can be sensed based on a change in a capacitance between movable electrode 31 and fixed electrode 33a, and based on a change in a capacitance between movable electrode 31 and fixed electrode 33b.

In X-sensing section 10 shown in FIG. 3, respective substantial centers of two sides of upper surface 11a of movable electrode 11 opposite to each other are connected to side walls of rectangular frame 10a via beams 12a and 12b. This configuration allows movable electrode 11 to swing about rotation axis A10 with respect to frame 3.

Fixed electrodes 13a and 13b are led out to upper surface 102a of upper lid layer 2a through via-electrodes 14a and 14b which are made of conductive material, such as Si, W or Cu. Insulative region 14c mainly made of insulative material, such as glass material supporting via-electrodes 14a and 14b are provide around via-electrodes 14a and 14b. In upper lid layer 2a, outer circumferential region 14d mainly made of Si is provided at an outer circumference of insulative region 14c.

As shown in FIG. 3, upper lid layer 2a includes projections 15 made of Si or W projecting downward from upper lid layer 2a. Lower lid layer 2b includes insulative region 14e made of insulative material, and outer circumferential region 14f mainly made of Si provided at an outer circumference of insulative region 14e. Lower lid layer 2b includes projections 16 made of Si or W and projecting upward from lower lid layer 2b.

In sensor 100 in accordance with Embodiment 1, upper lid layer 2a and projections 15 are made of Si. Since Si can be processed easily, projections 15 can be formed on upper lid layer 2a easily. Similarly, lower lid layer 2b and projections 16 are made of Si. Since Si can be processed easily, projections 16 can be formed on lower lid layer 2b easily.

In sensor 100 in accordance with Embodiment 1, via-electrodes 14a and 14b are made of Si, so that both of the outer peripheries 14d and 14f provided at outer walls of upper lid layer 2a and lower lid layer 2b can be formed simultaneously to via-electrodes 14a and 14b. This configuration reduces the number of processes for manufacturing the sensor 100.

In Y-sensing section 20, respective substantial centers of two sides of upper surface 21a of movable electrode 21 opposite to each other are connected to side walls of rectangular frame 20a via beams 22a and 22b. This configuration allows movable electrode 21 to swing about rotation axis A20 with respect to frame 3. Fixed electrodes 23a and 23b are led out to upper surface 102a of upper lid layer 2a through via-electrodes 24a and 24b.

Via-electrodes 24a and 24b are mainly made of conductive material, such as Si, W, or Cu. Insulative region 14c supporting via-electrodes 24a and 24b are provided around via-electrodes 24a and 24b. Outer circumferential region 14d is provided at an outer circumference of insulative region 14c of upper lid layer 2a.

In Z-sensing section 30, as shown in FIG. 4, four corners of movable electrode 31 are connected to side walls of rectangular frame 30a via beams 32a, 32b, 32c, and 32d having L-shapes. This configuration allows movable electrode 31 to move in a vertical direction. The shape of these beams is not limited; however, the L-shapes allow these beams to be longer than other shapes.

Fixed electrode 33a, is disposed on lower surface 202a of upper lid layer 2a, and faces movable electrode 31. Fixed electrode 33b is disposed on upper surface 102b of lower lid layer 2b, and faces movable electrode 31. Fixed electrode 33a is led out to upper surface 102a of upper lid layer 2a through via-electrode 34a. Fixed electrode 33b includes projection region 33b2 projecting from rectangular region 33b1 (see FIG. 2B).

Projection region 33b2 is connected to fixed electrode 34c that is separated from movable electrode 31 and has a pillar shape. Fixed electrode 34c is connected to via-electrode 34b formed in upper lid layer 2a. This structure allows the fixed electrode 33b to be led out to upper surface 102a of upper lid layer 2a through fixed electrode 34c and via-electrode 34b. Via-electrodes 34a and 34b are made of conductive material, such as Si, W, or Cu. Insulative region 14c supporting via-electrodes 34a and 34b is provided around via-electrodes 34a and 34b.

In upper lid layer 2a, outer circumferential region 14d is provided at an outer circumference of insulative region 14c. Lower lid layer 2b includes insulative region 14e and outer circumferential region 14f provided at an outer circumference of insulative region 14e.

An operation of sensor 100 in accordance with Embodiment 1 will be described below with reference to accompanying drawings.

### (Sensing Accelerations in Directions of K-Axis and Y-Axis])

Capacitance C formed by electrodes facing each other can be calculated by the formula, C=∈S/d, with a dielectric constant ∈ between the electrodes, area S at which the electrodes faces each other, and distance d between the electrodes. Rotations of movable electrodes 11 and 21 due to an acceleration changes distance d, and changes capacitance C accordingly. Processor 200 executes CV conversion for converting the change of capacitance C into a voltage.

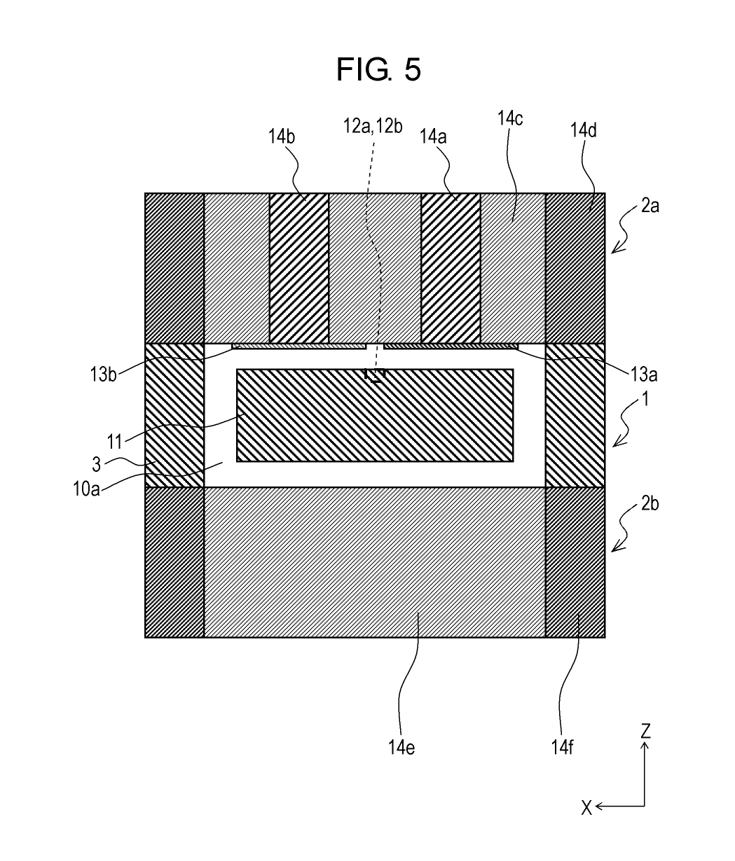

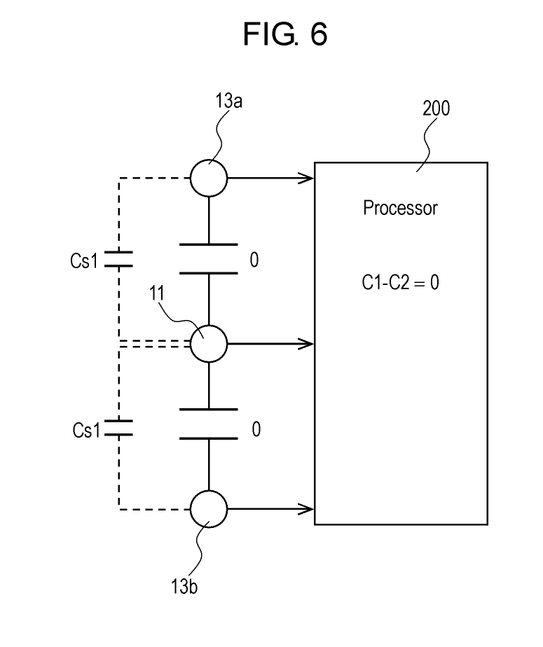

FIG. 5 is a sectional view of sensor 100 having no acceleration in a direction of the X-axis applied thereto, and particularly illustrates a cross section of K-sensing section 10. FIG. 6 is a schematic view of sensor 100 having no acceleration in a directions in the X-axis applied thereto for illustrating an operation of sensor 100. In this case, as shown in FIG. 6, capacitance C1 formed between movable electrode 11 and fixed electrode 13a is equal to capacitance C2 formed between movable electrode 11 and fixed electrode 13b. Each of capacitances C1 and C2 is equal to parasitic capacitance Cs1 (C1=C2=Cs1). Processor 200 calculates a difference (C1−C2=Cs1−Cs1=0) between capacitances C1 and C2, and then, outputs the difference as an X-output.

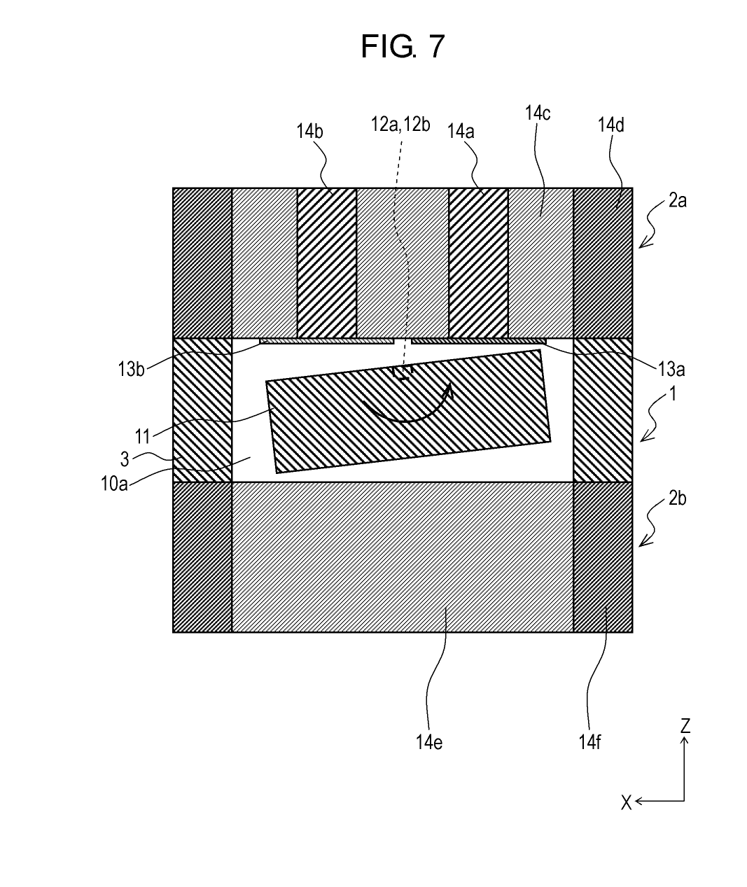

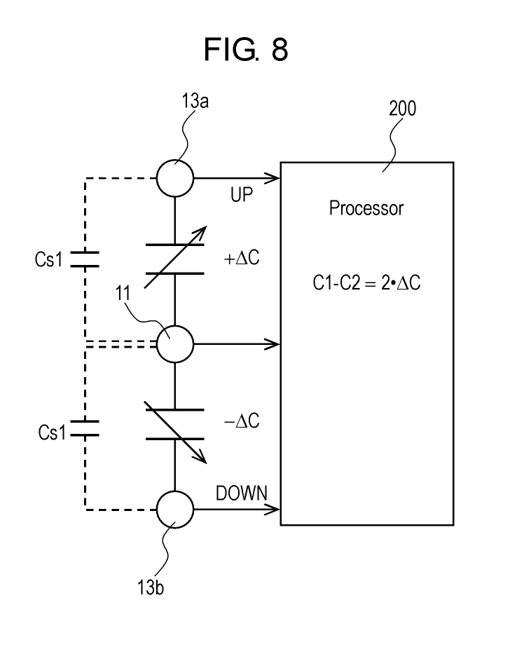

FIG. 7 is a sectional view of sensor 100 having an acceleration of 1G in a direction of the X-axis applied thereto, and particularly illustrates a cross section of X-sensing section 10. FIG. 8 is a schematic diagram of sensor 100 having the acceleration in the direction of the X-axis applied thereto for illustrating an operation of sensor 100. In this case, capacitance C1 formed between movable electrode 11 and fixed electrode 13a is expressed as Cs1+ΔC as shown in FIG. 8. Capacitance C2 formed between movable electrode 11 and fixed electrode 13b is expressed as Cs1−ΔC. Processor 200 calculates a difference (C1−C2=Cs1+ΔC−(Cs1−ΔC)=2·ΔC) between capacitances C1 and C2, and then outputs the difference as an X-output.

Based on the changes of capacitances C1 and C2, X-sensing section 10 senses the acceleration in the direction of the X-axis based on the X-output that is changed by the acceleration. Y-sensing section 20 can sense an acceleration in a direction of the Y-axis similarly to X-sensing section 10.

### (Sensing Acceleration in Direction of Z-Axis)

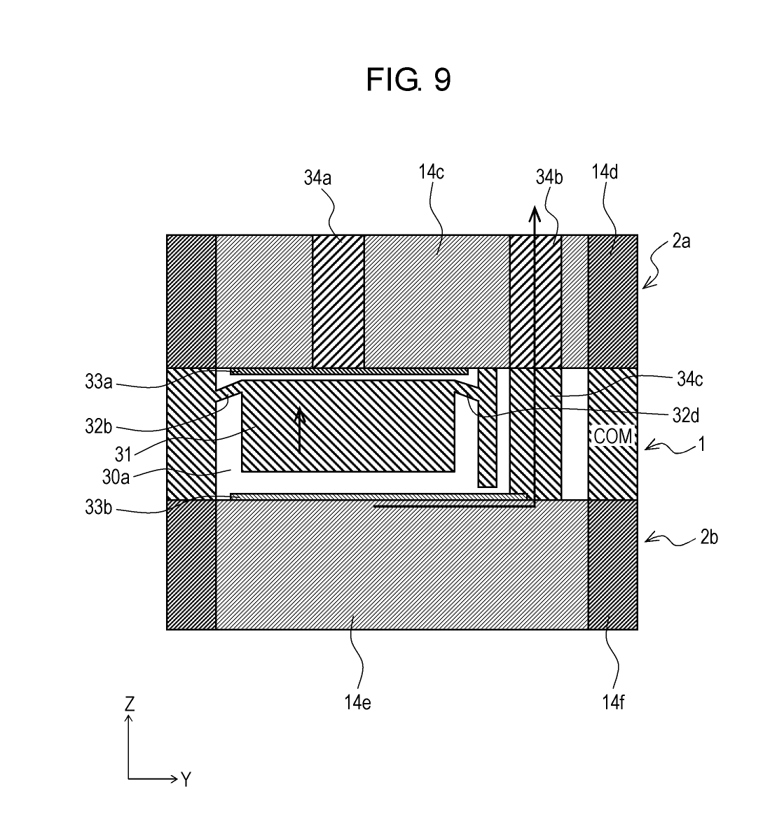

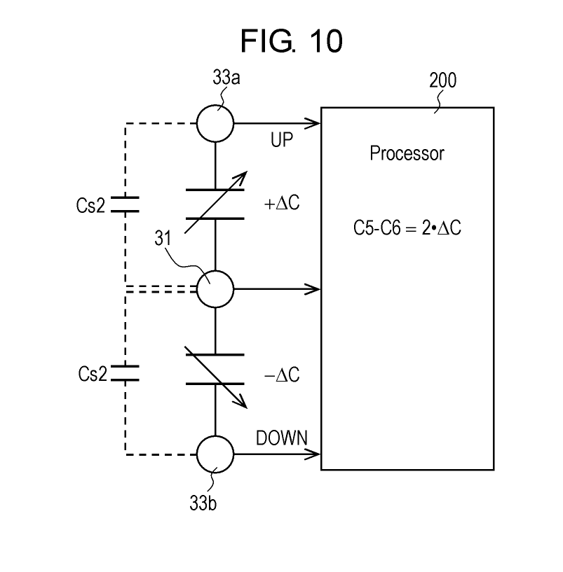

FIG. 9 is a sectional view of sensor 100 having an acceleration of 1G in a direction of the Z-axis applied thereto, and particularly illustrates a cross section of Z-sensing section 30. FIG. 10 is a schematic diagram of sensor 100 having the acceleration in the direction of the Z-axis applied thereto for illustrating an operation of sensor 100. While an acceleration in a direction of the Z-axis is not applied, each of capacitance C5 between movable electrode and fixed electrode 33a and capacitance C6 between movable electrode 31 and fixed electrode 33b is equal to parasitic capacitance Cs2. Processor 200 calculates a difference (C5−C6=Cs2−Cs2=0) between capacitances 5 and 6, and then outputs the difference as a Z-output. While the acceleration along the Z-axis is applied to sensor 100, as shown in FIG. 10, capacitance C5 is expressed as Cs2+ΔC, and capacitance C6 is expressed as Cs2−ΔC. Processor 200 calculates the difference (C5−C6=Cs2−ΔC−(Cs2−ΔC)=2·ΔC) between capacitances C5 and C6, and then outputs the difference as a Z-output. Based on the changes of capacitances C5 and C6, Z-sensing section 30 senses the acceleration along the Z-axis based on the Z-output that is changed by the acceleration.

In sensor 100 in accordance with Embodiment 1, via-electrodes 14a and 14b covered with insulative region 14c are formed in upper lid layer 2a; however, via-electrodes covered with an insulative region can be formed in lower lid layer 2b instead of upper lid layer 2a. This structure provides the same effects as those discussed previously.

### (Method for Manufacturing Sensor 100)

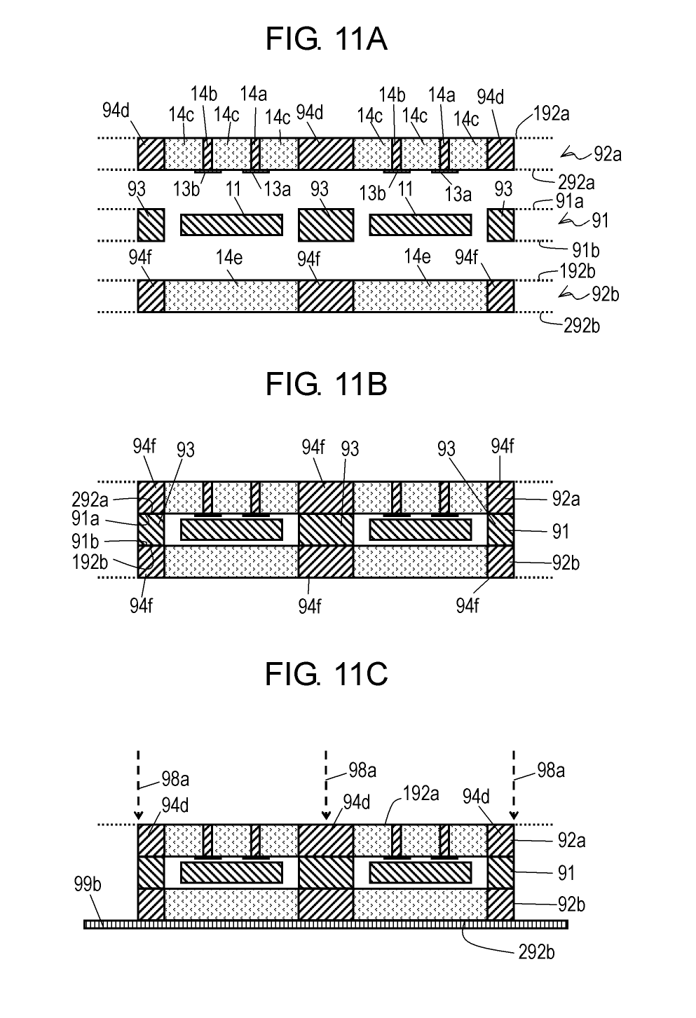

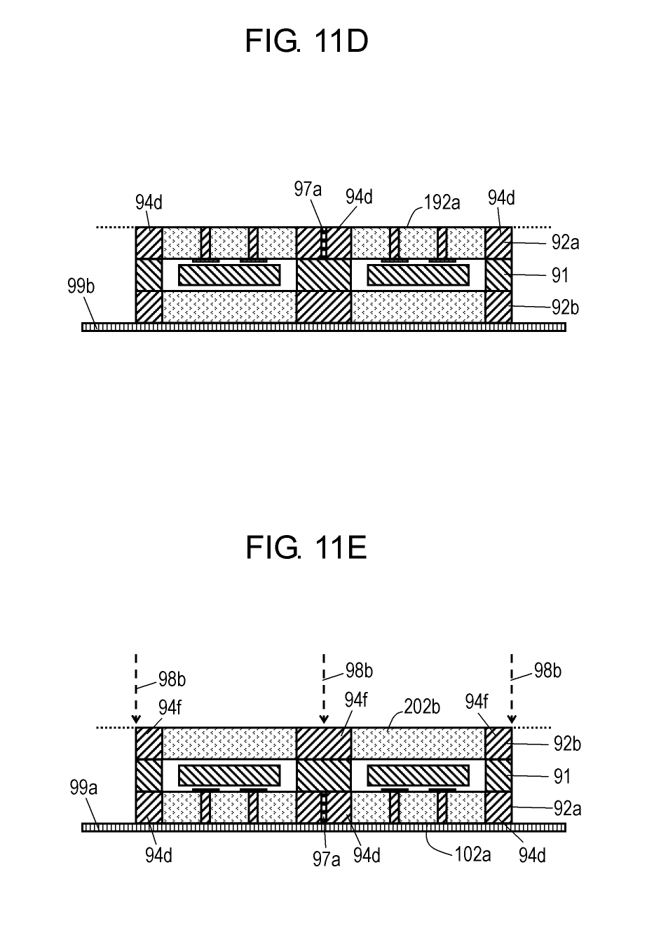

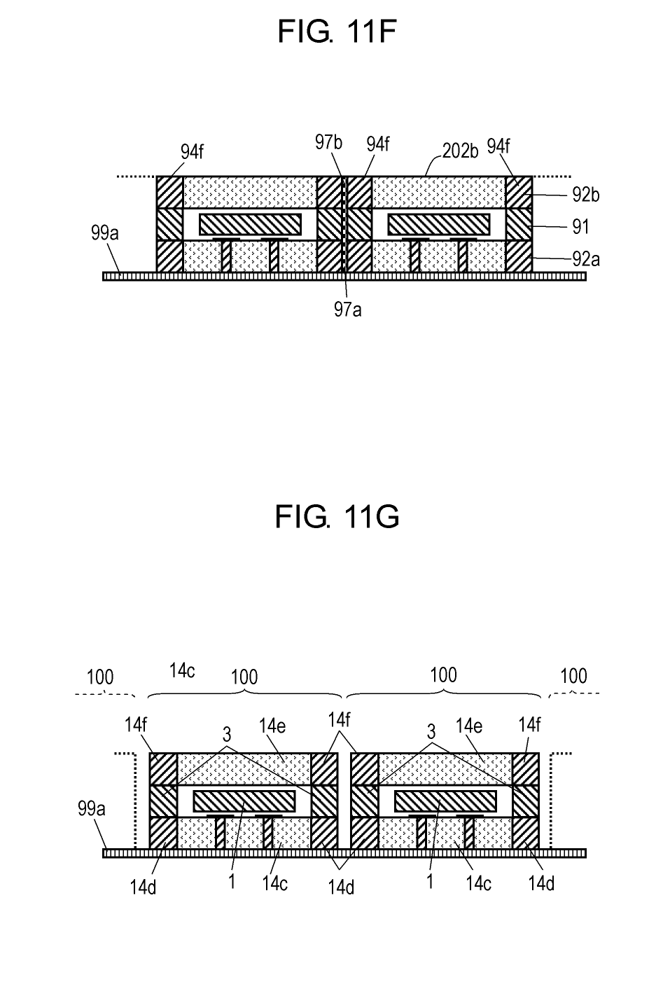

FIGS. 11A to 11G are sectional views of sensor 100 in accordance with Embodiment 1 for illustrating a method of manufacturing sensor 100, and illustrate cross sections of X-sensing section 10 similarly to FIG. 3.

As shown in FIG. 11A, wafer 91 made of conductive material, such as Si, and wafers 92a and 92b made of conductive material such as Si and insulative material, such as glass, are prepared. Wafer 91 has upper surface 91a and lower surface 91b, and constitutes sensor layer 1. Wafer 92a has upper surface 192a and lower surface 292a, and constitutes upper lid layer 2a. Wafer 92b has upper surface 192b and lower surface 292b, and constitutes lower lid layer 2b.

Wafer 91 includes frame 93 having plural rectangular frames 10a passing from upper surface 91a to lower surface 91b, beams 12a and 12b (see FIG. 2B) connected to frame 93, and plural movable electrodes 11 coupled to frame 93 via beams 12a and 12b (see FIG. 2B). Each of movable electrodes 11 is disposed in respective one of rectangular frames 10. In frame 93, rectangular frames 20a and rectangular frames 30a are further disposed (see FIG. 2B). These rectangular frames pass from upper surface 91a to lower surface 91b. Wafer 91 further includes beams 22a and 22b connected to frame 93 (see FIG. 2B), plural movable electrodes 21 coupled to frame 93 via beams 22a and 22b (see FIG. 2B), beams 32a to 32d connected to frame 93, and plural movable electrodes 31 coupled to frame 93 via beams 32a to 32d (see FIG. 2B). Each of movable electrodes 21 is disposed in respective one of rectangular frames 20a. Each of movable electrodes 31 is disposed in respective one of rectangular frames 30a. The following describes only the vicinity of movable electrode 11 of X-sensing section 10; however, movable electrode 21 of Y-sensing section 20 and movable electrode 31 of Z-sensing section 30 have similar vicinity.

Wafer 92a includes plural insulative regions 14c, conductive regions 94d made of Si each provided around respective one of insulative regions 14c to surround respective one of insulative regions 14c. As shown in FIG. 3, via-electrodes 14a and 14b are formed in each of insulative regions 14c. Conductive regions 94d constitutes outer circumferential region 14d. Fixed electrodes 13a and 13b connected to via-electrodes 14a and 14b, respectively are disposed on lower surface 292a of wafer 92a.

Wafer 92b includes plural insulative regions 14e, conductive regions 94f made of Si each provided around respective one of insulative regions 14e to surround respective one of insulative regions 14e. Conductive regions 94f constitutes outer circumferential region 14f.

Next, as shown in FIG. 11B, lower surface 292a of wafer 92a is bonded to upper surface 91a of wafer 92a such that frame 93 of wafer 91 contacts conductive region 94d of wafer 92a. Upper surface 192b of wafer 92b is bonded to lower surface 91b of wafer 91 such that frame 93 of wafer 91 contacts conductive region 94f of wafer 92b.

Next as shown in FIG. 11C, tape 99b is attached onto lower surface 292b of wafer 92b, and conductive region 94d of upper surface 192a of wafer 92a is irradiated with laser beam 98a. As a result, modified layer 97a is formed at a region of conductive region 94d irradiated with the laser beam 98a. Then, tape 99a is irradiated with an ultraviolet ray for weakening adhesive of the tape, thereby removing tape 99b.

Next, as shown in FIG. 11E, tape 99a is attached onto upper surface 192a of wafer 92, and tape 99b is removed from lower surface 292b of wafer 92b. Then, conductive region 94f of lower surface 292b of wafer 92b is irradiated with laser beam 98b. As a result, modified layer 97b is formed at a region of conductive region 94f where laser beam 98b is irradiated, as shown in FIG. 11F. This region is connected with modified layer 97a. Then, tape 99a is irradiated with an ultraviolet ray for weakening adhesive of the tape thereby removing tape 99a.

Next as shown in FIG. 11G, tape 99a is stretched, thereby stretching conductive regions 94d and 94f and frame 93, so that each of conductive regions 94d and 94f and frame 93 is divided by modified layers 97a and 97b connected to the regions and the frame into sensors 100 each including outer circumferential region 14f of upper lid layer 2a, outer circumferential region 14f of lower-lid layer 2b, and frame 3 of sensor layer 1. Sensors 100 are then removed from tape 99a.

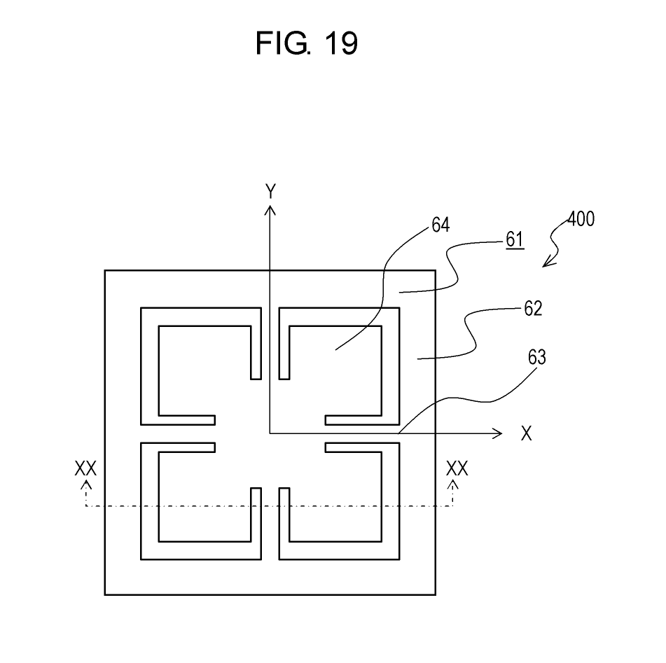

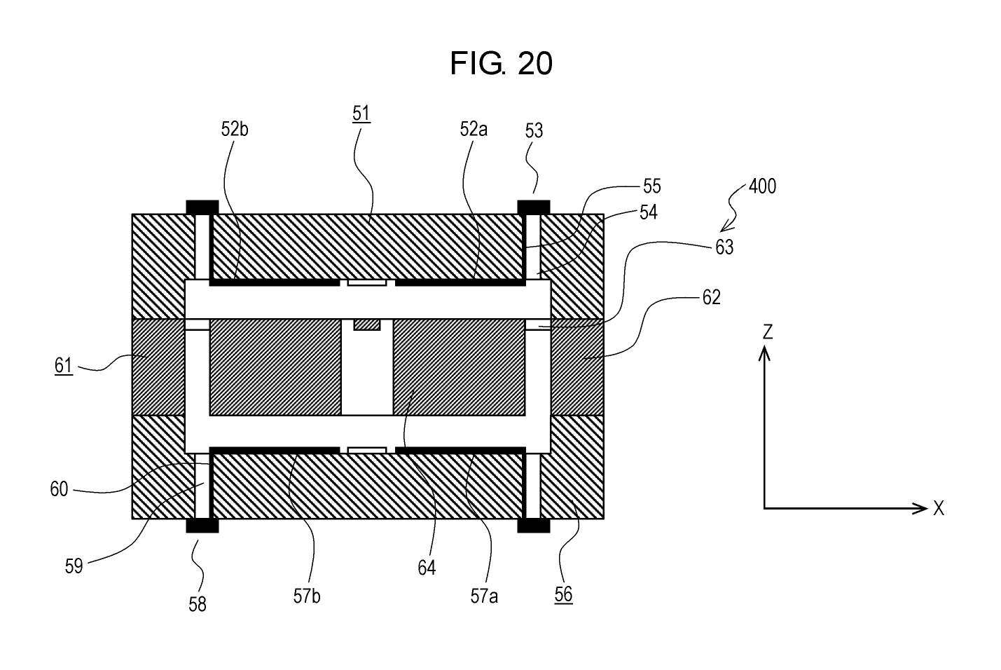

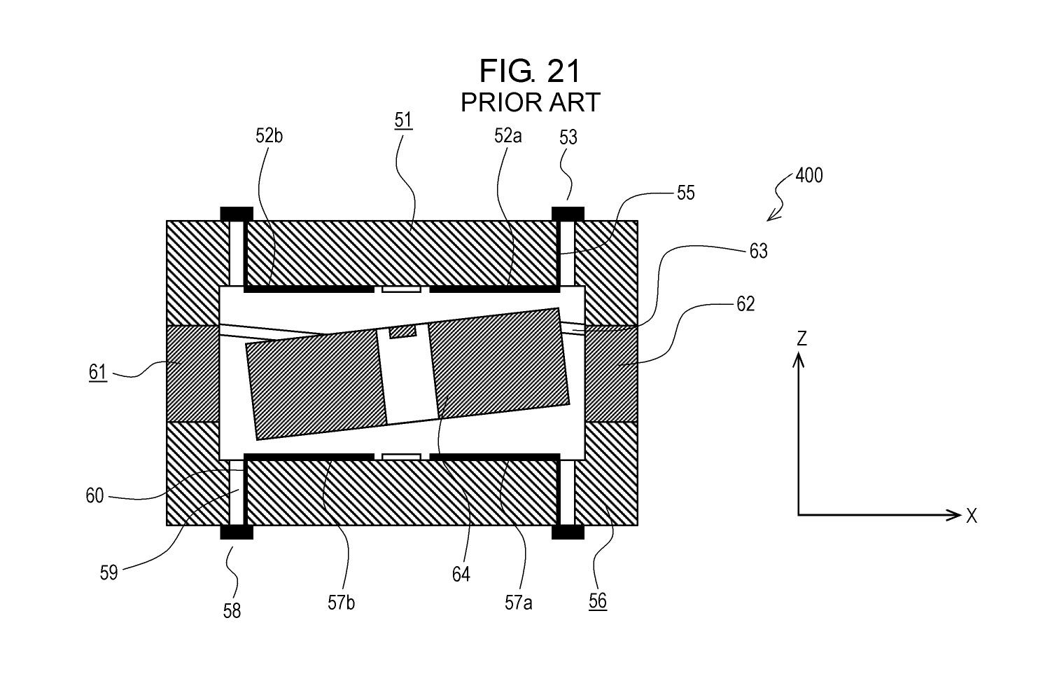

In conventional sensor 400 shown in FIG. 19, upper lid layer 51 and lower lid layer 56 both made of glass are separated from glass wafers by a blade-dicing method during a manufacturing process. The blade-dicing method requires a large margin for cutting, accordingly increases the dimensions of the wafers to endure the margin.

In sensor 100 in accordance with Embodiment 1, outer circumferential regions 14d and 14f are provided at outer peripheries of upper lid layer 2a and lower lid layer 2b, respectively. Then conductive regions 94d and 94f of wafers 92a and 92b constituting outer circumferential regions 14d and 14f are irradiated with laser beam 98a and 98b for forming modified layers 97a and 97b. Then, upper lid layer 2a and lower lid layer 2b are stretched for separation. This separation requires a small margin for cutting, accordingly allowing the outer dimensions of wafers 91, 92a, and 92b to be small.

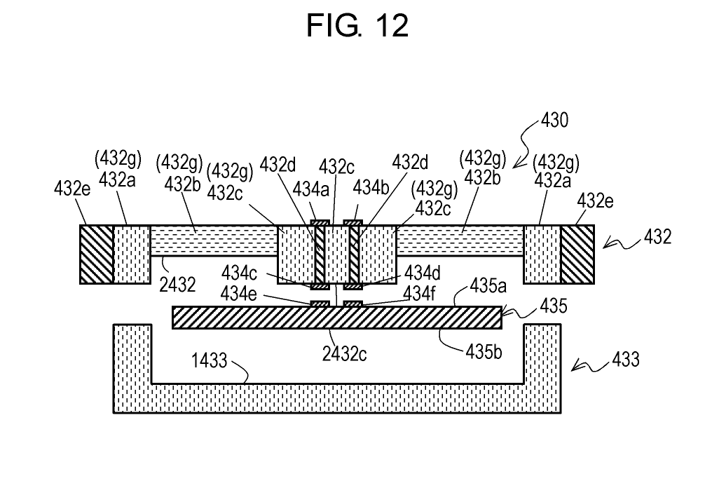

FIG. 12 is an exploded perspective view of another sensor 430 in accordance with Embodiment 1. Sensor 430 includes upper lid layer 432, lower lid layer 433, and sensor layer 435 disposed between upper lid layer 432 and lower lid layer 435. Lower surface 2432 of upper lid layer 432 faces upper surface 435a of sensor layer 435 while upper surface 1433 of lower lid layer 433 faces lower surface 435b of sensor layer 435. Upper lid layer 432 is bonded to lower lid layer 433 to form a space between upper lid layer 432 and lower lid layer 433 capable of accommodating sensor layer 435. Electrodes 434a and 434b are formed on upper lid layer 432, and are connected to electrodes formed on a circuit board via wires. Sensor layer 435 is displaced in response to inertial force, such as acceleration, applied thereto.

Upper lid layer 432 includes opposing section 432b facing sensor layer 435, via-electrodes 432d coupled to sensor layer 435, outer circumferential region 432e provided at an outer circumference of the upper lid layer 432. Via-electrodes 432d and outer circumferential region 432e are made of Si. Upper lid layer 432 further includes bonding section 432a bonded to lower lid layer 433, fringe section 432c disposed at a fringe of via-electrodes 432d. Opposing section 432b, bonding section 432a, and fringe section 432c are made of insulative material, such as glass material, and constitute insulative region 432g.

Each of via-electrodes 432d includes electrodes 434a and 434b having respective one ends configured to be electrically connected with a circuit board through wires, and includes electrodes 434c and 434d electrically connected with sensor layer 435. Sensor layer 435 includes electrodes 434e and 434f connected with via-electrodes 432d.

Lower lid layer 433 is made of insulative material, such as glass material, and has a recess provided therein. Bonding the lower lid layer 433 to the upper lid layer 432 allows this recess to form the space accommodating sensor layer 435 therein.

As discussed above, upper lid layer 432 of sensor 430 includes insulative region 432g mainly made of glass, via-electrodes 432d covered with insulative region 432g, and outer circumferential region 432e mainly made of Si provided at an outer circumference of insulative region 432g.

### Exemplary Embodiment 2

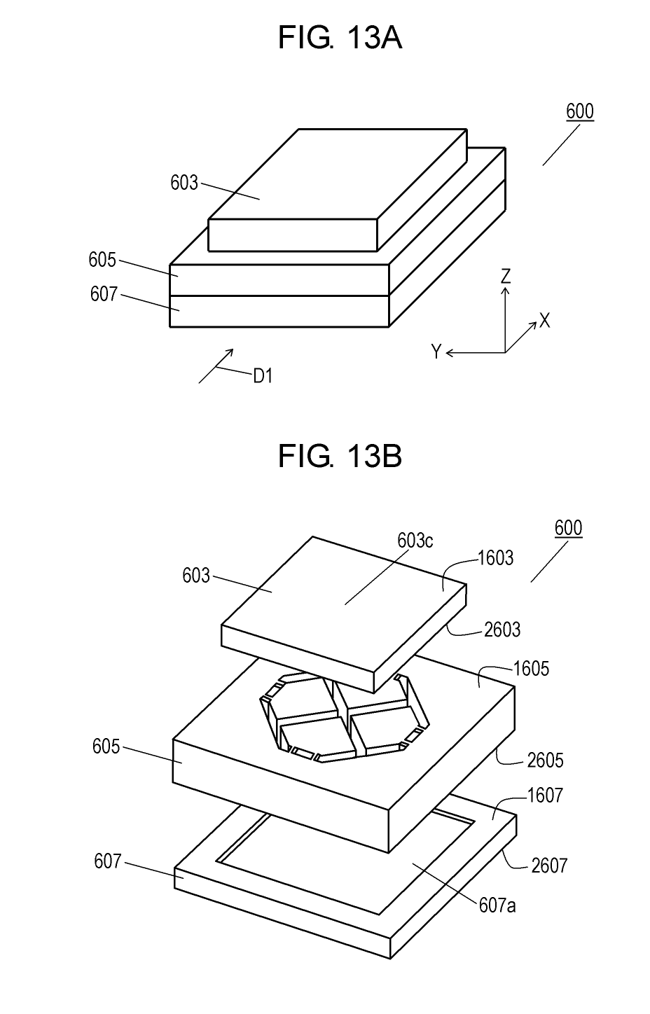

FIG. 13A and FIG. 13B are a perspective view and an exploded perspective view of sensor 600 in accordance with Exemplary Embodiment 2. Sensor 600 in accordance with Embodiment 2 is an acceleration sensor sensing an acceleration.

Sensor 600 includes substrate 603 as an upper lid, substrate 605 as a sensing element, and substrate 607 as a lower lid connected to substrate 605. Substrate 605 includes supporter 522 is connected to substrate 603. Substrate 603 includes a roughened region in at least a part of a surface of substrate 306 facing substrate 605.

Substrates 603, 605, and 607 can be made of silicon, fussed quartz, or aluminum oxide. These substrates are preferably made of silicon, hence providing sensor 600 with a small size manufactured by using a micro-processing technique. Substrate 603 has surfaces 1603 and 2603 opposite to each other. Substrate 605 has surfaces 1605 and 2605 opposite to each other. Substrate 607 has surfaces 1607 and 2607 opposite to each other. Surface 2603 of substrate 603 faces surface 1605 of substrate 605 while surface 2605 of substrate 605 faces surface 1607 of substrate 607.

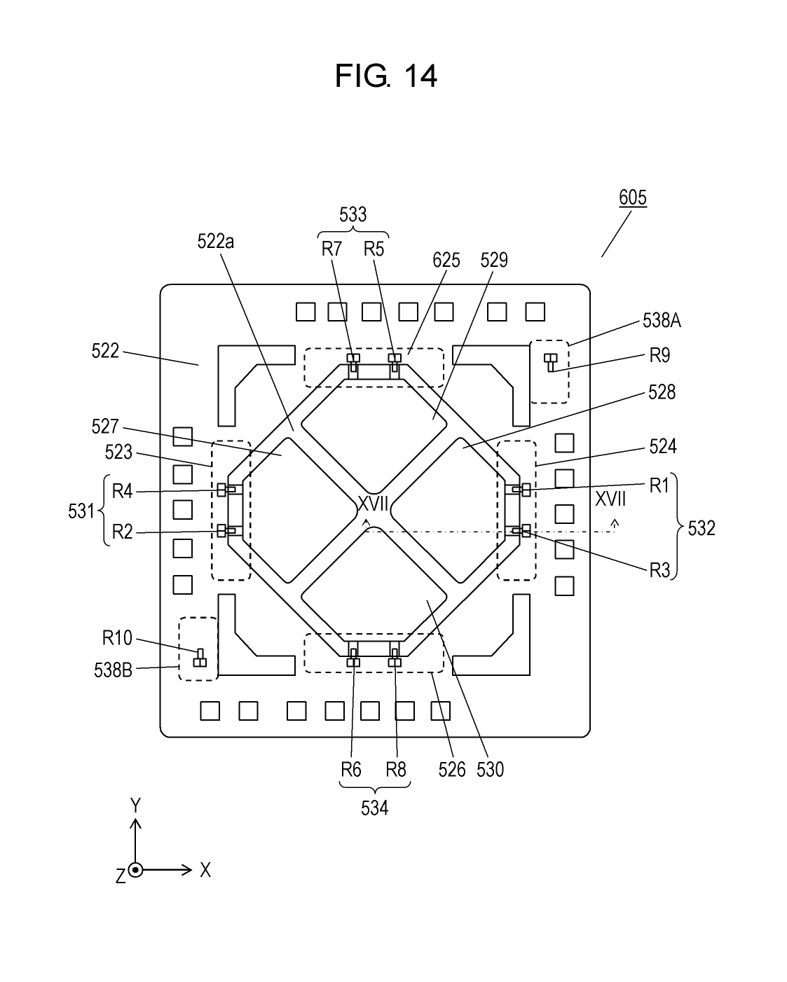

FIG. 14 is a plan view of substrate 605 constituting the sensing element. In FIG. 14, an X-axis, a Y-axis, and a Z-axis perpendicular to one another are defined. Substrate 605 includes supporter 522, beams 523 to 526, movable sections 527 to 530, and sensing sections 531 to 534 provided on beams 523 to 526, respectively. Respective one ends of beams 523 to 526 are connected to supporter 522 while respective another ends of beams 523 to 526 are connected to movable sections 527 to 530, respectively. Hollow region 522a is provided inside supporter 522. Beams 523 to 526 extend from supporter 522 toward hollow region 522a. Movable section 527 faces movable section 528 in a direction of the X-axis. Movable section 529 faces movable section 530 in a direction of the Y-axis.

Sensing section 531 includes stress-sensitive resistors R2 and R4. Sensing section 532 is formed of stress-sensitive resistors R1 and R3. Sensing section 533 is formed of stress-sensitive resistors R5 and R7. Sensing section 534 is formed of stress-sensitive resistors R6 and R8. Sensing sections 538A and 538B are provided on supporter 522, and include stress-sensitive resistor R9 and R10, respectively. Sensing sections 538A and 538B are provided on supporter 522 that does not deform due to an acceleration, so that stress-sensitive resistor R9 and R10 function as fixed resistors having resistances not changing due to an acceleration. Stress-sensitive resistors R1 to R10 have similar structures, hence having resistances changing similarly to an external environment, such as temperature and humidity. A bridge connection of stress-sensitive resistors R1 to R10 cancels out the change of the resistance caused by external environment, so that this sensor can sense an acceleration accurately regardless of external environment.

An acceleration applied to substrate 605 in a positive direction of the X-axis causes movable section 528 to move in a negative direction of the Z-axis as well as movable section 527 to move in a positive direction of the Z-axis. This configuration increases the resistances of stress-sensitive resistors R1 and R3, and decreases the resistance of stress-sensitive resistors R2 and R4. An acceleration applied to substrate 605 in the negative direction of the X-axis causes movable sections 527 and 528 to move opposite to the above directions, and causes the resistances of stress-sensitive resistors R1 to R4 to change opposite to the above direction. The changes in the resistances are sensed as changes in a voltage, thereby sensing the acceleration in the directions of the X-axis.

An acceleration applied to substrate 605 in a positive direction of the Y-axis causes movable section 529 to move in a positive direction of the Z-axis as well as movable section 530 to move in a negative direction of the Z-axis. This configuration increases the resistances of stress-sensitive resistors R5 and R7, and decreases the resistances of stress-sensitive resistors R6 and R8. An acceleration applied substrate 605 in the negative direction of the Y-axis causes movable sections 529 and 539 to move opposite to the above directions, and causes the resistances of stress-sensitive resistors R5 to R8 to change opposite to the above directions. The changes in the resistances are sensed as changes in a voltage, thereby sensing the acceleration in the directions of the Y-axis.

An acceleration applied to substrate 605 in a positive direction of the Z-axis causes movable sections 528 to 530 to move in the positive direction of the Z-axis. This configuration increases the resistances of stress-sensitive resistors R1 to R8. An acceleration applied to substrate 605 in the negative direction of the Z-axis causes movable sections 527 to 530 to move opposite to the above direction, and causes the resistances of stress-sensitive resistors R1 to R8 to change opposite to the above direction. The resistances of stress-sensitive resistors R9 and R10 do not change due to the acceleration. The changes in the resistances are sensed as changes in a voltage, thereby sensing the acceleration in the directions of the Z-axis.

Sensor 600 in accordance with Embodiment 2 includes substrate 605 constituting a sensing element for sensing accelerations in three directions; however, sensor 600 is not limited to this instance. For example, substrate 605 may include only supporter 522, beam 523, movable section 527, and sensing section 531 for sensing an acceleration in one direction.

Movable sections 527 to 530 can be supported with two beams opposite to each other, namely, both-ends supporting structure, or one movable section can be supported beams extending in four directions. The movable sections can be supported by a membrane structure, such as a diaphragm. In other words, the structure of the beams may support the movable sections such that the movable sections can move in response to an acceleration.

Sensing sections 531 to 534 can employ a stress-sensitive resistor method, and use of a piezo-resistor as the stress-sensitive resistor improves the sensitivity of sensor 600. A thin-film resistor method, one of the stress-sensitive resistor method, employing an oxide-film stress-sensitive resistor improves temperature characteristics of sensor 600.

Sensor 600 in accordance with Embodiment 2 senses an acceleration; however, sensor 600 can be configured to sense another inertial force, such as an angular velocity. A sensor for sensing an angular speed is disclosed in, for instance, Japanese Patent Laid-Open Publication No. 2013-15529 and Japanese Patent Laid-Open Publication No. 2005-514609.

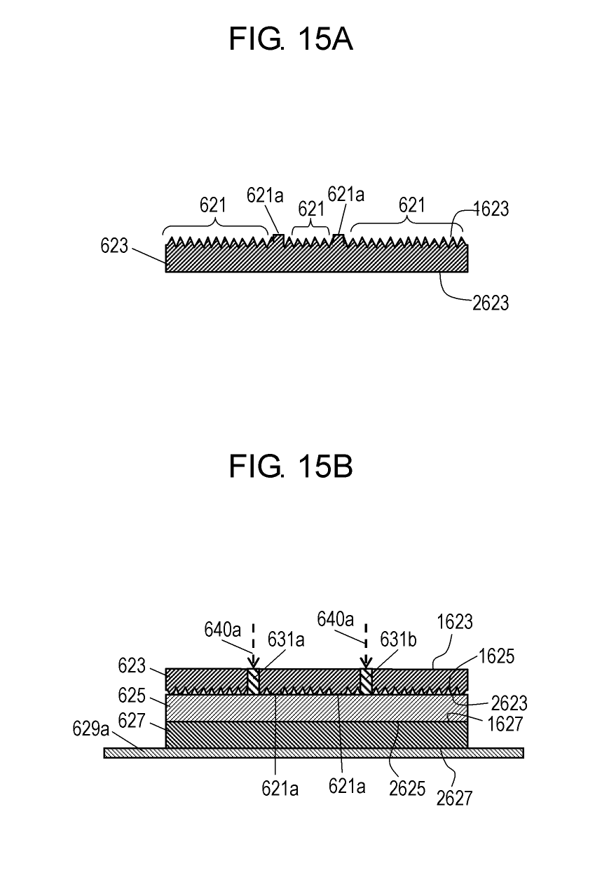

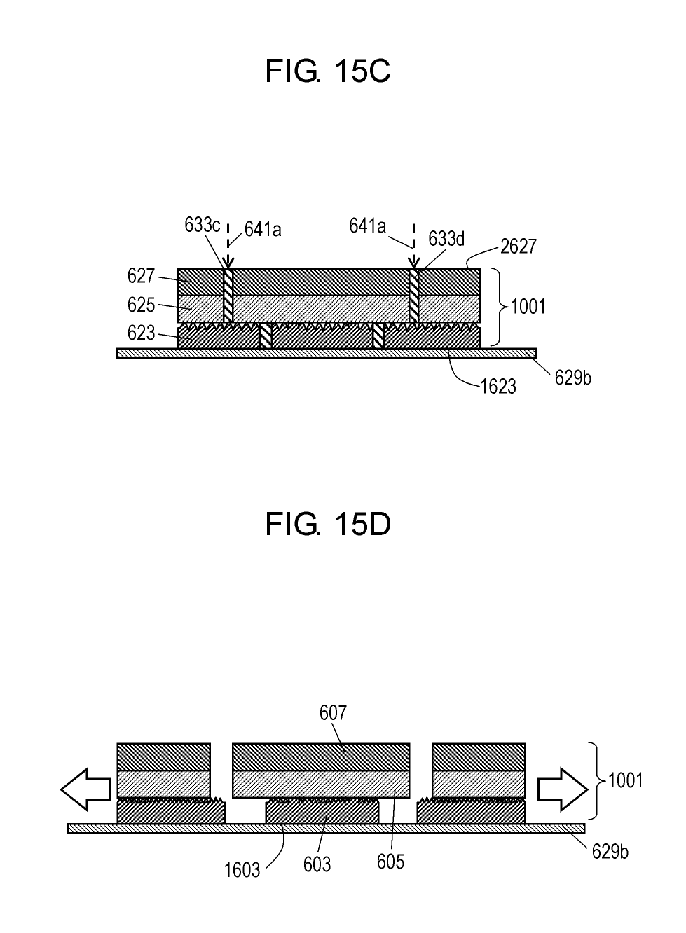

A method for manufacturing sensor 600 will be described below. FIGS. 15A to 15D are sectional views of sensor 600 for illustrating the method of manufacturing sensor 600. Upper lid wafer 623 has surfaces 1623 and 2623 opposite to each other, and is diced to be divided into substrates 603. Sensing element wafer 625 has surfaces 1625 and 2625 opposite to each other, and is diced to be divided into substrates 607. FIGS. 15A to 15D illustrate sections of layering upper lid wafer 623, sensing element wafer 625, and lower lid wafer 627 viewing inn direction D1 shown in FIG. 13A during a dicing process.

First, as shown in FIG. 15A, roughened region 621 of surface 2623 out of surfaces 1623 and 2623 of upper lid wafer 623 other than non-roughened region 621a of surface 2623 is roughened. Upper lid wafer 623 is made of silicon. Roughened region 621 of surface 2623 is roughened by the following method. Oxide films made of SiO₂ are formed on both surfaces 1623 and 2623 of upper lid wafer 623 by for example, thermal oxidation. Then, photo-sensitive resist is applied onto roughened region 621 on the surface of the oxide film. Roughened region 621 then undergoes a photolithography process, such as an exposure process and a development process of semiconductor, thereby forming a mask made of oxide film (SiO₂). Then, the oxide film on the surface is etched with buffering-hydrofluoric acid, and the resist is removed by ashing. As a result, the mask pattern made of the oxide films (SiO₂) can be formed. Then, upper lid wafer 623 is dipped into mixed acid, having an appropriate ratio of concentration and formed of hydrofluoric acid and nitric acid, for selectively etching a region of surface 1623 of upper lid wafer 623 which is not covered with the mask, so that this region can be roughened. Then, the mask can be removed by etching with, for example, the hydrofluoric acid, thereby selectively forming non-roughened region 621a (smooth surface) and roughened region 621 on the upper lid wafer 623. Non-roughened region 621a is smoother than the roughened region 621.

Next, as shown in FIG. 15B, upper lid wafer 623, sensing element wafer 625, and lower lid wafer 627 are stacked together such that roughened surface 2623 of upper lid wafer 623 faces surface 1625 of sensing element wafer 625, and surface 2625 of sensing element wafer 625 faces surface 1627 of lower lid wafer 627, thereby providing laminated body 1001. Laminated body 1001 is disposed on tape 629a such that tape 629a is attached onto surface 2627 of lower lid wafer 627. Then, surface 1623 of upper lid wafer 623 is irradiated with laser beam 640a for forming modified layers 631a and 631b in upper lid wafer 623.

Laser beam 640a can employ, for instance, Yttrium Aluminum Garnet (YAG) laser beam.

Next, as shown in FIG. 15C, laminated body 1001 is turned upside down, and tape 629b is attached onto surface 1623 of upper lid wafer 623. Then, laser beam 640a enters from surface 2627 of lower lid wafer 627 into lower lid wafer 627 and sensing element wafer 625 for forming modified layers 633a and 633b in lower lid wafer 627 and sensing element wafer 625. The interval between modified layers 633a and 633b is larger than the interval between modified layers 631a and 631b.

Next, as shown in FIG. 15D, tape 629b is stretched so that laminated body 1001 can receive tensile stress. As a result, upper lid wafer 623, sensing element wafer 625, and lower lid wafer 633b are separated at modified layers 631b, 633a, and 633b, thus providing sensor 600.

The conventional sensor disclosed in PTL 2 includes a modified layer in an upper lid wafer, so that a part of a laser beam arrives at a sensing element wafer. The laser may damage the sensing element wafer.

During the manufacturing of sensor 600 in accordance with Embodiment 2, roughened region 621 is provided onto surface 2623 of upper lid wafer 623 facing sensing element wafer 625. This structure prevents laser beam 640a to be used for forming modified layers 631a and 631b from penetrating to and being focused on the sensing element wafer 625. As a result, the damage to sensing element wafer 625 can be prevented. This advantage will be detailed below.

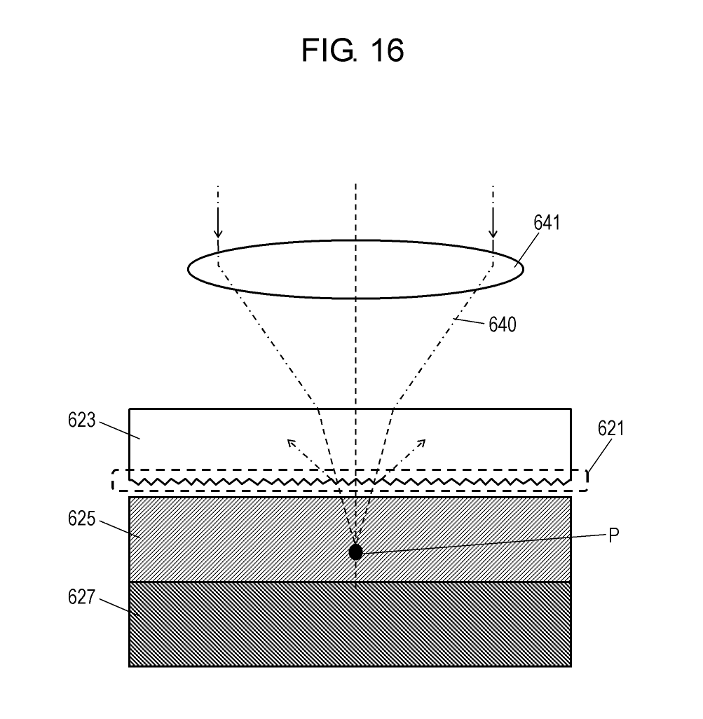

FIG. 16 is a schematic view of upper lid wafer 623 for schematically illustrating laser beam 640a irradiated onto upper lid wafer 623 for forming modified layer 631a (631b). For simple description, a portion at which upper lid wafer 623 is bonded to sensing element wafer 625 is omitted in FIG. 16.

Laser beam 640a is deflected with lens 641, and enters into upper lid wafer 623 or sensing element wafer 625. At this moment, if there is no roughened regions, laser beam 641a passes through upper lid wafer 623 with little attenuation, and focuses on point P of sensing element wafer 625. As a result, sensing element wafer 625 is damaged around point P. On the other hand, upper lid wafer 623 in accordance with Embodiment 2 includes surface 2623 facing sensing element wafer 625 and having roughened region 621. When laser beam 640a passes across the interface between upper lid wafer 623 and sensing element wafer 625, laser beam 640a is diffused by roughened region 621. This configuration drastically reduces energy of laser beam 640a concentrating to point P in sensing element wafer 625, hence preventing sensing element wafer 625 from damage.

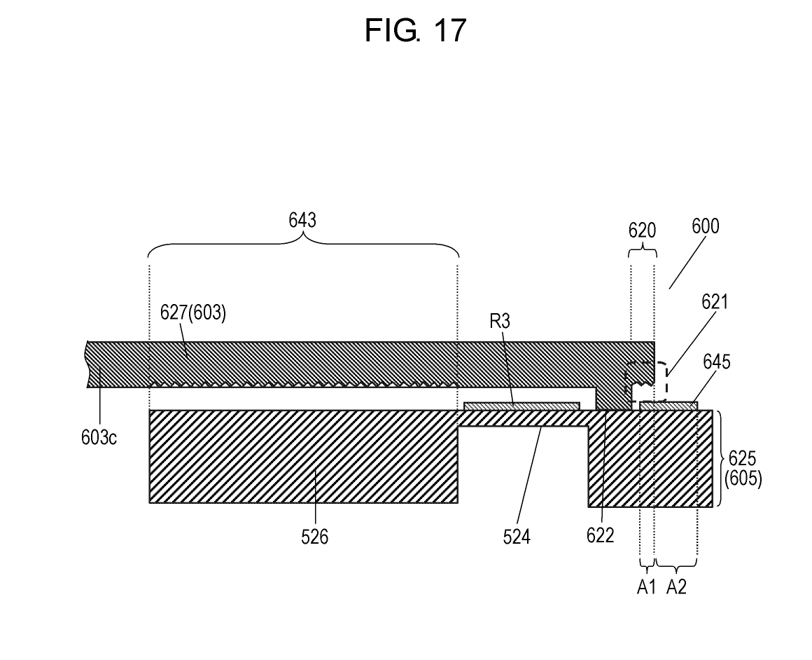

FIG. 17 is a sectional view of sensor 600 along line XVII-XVII shown in FIG. 14. Surface 2603 of substrate 603 includes roughened region 621 and bonding section 622. As shown in FIG. 17, roughened region 621 is formed on substrate 603 opposite to the position which laser beam 640a enters. That is, roughened region 621 is provided at periphery 620 of substrate 603 facing substrate 605. Roughened region 621 is thus located farther from center 603c of substrate 603 than bonding section 622 that bonds substrate 603 to substrate 605. Roughened region 621 has a rougher surface than surface 1603 opposite to surface 2603 of substrate 603 facing substrate 605. Roughened region 621 of surface 2603 has a rougher surface than bonding section 622 joined to surface 1605 of substrate 605. Roughened region 621 is located closer to surface 1605 than bonding section 622.

Arithmetic average roughness Ra of roughened region 621 is not smaller than about 600 nm.

Arithmetic average roughness Ra is expressed in micro meters and is given by Formula 1 in which, while a reference length L extracted from a roughness curve in an average line direction, the X-axis is defined in the average line direction of the extracted part, and the Y-axis is defined in profilver grosserung direction, the roughness curve Y=f(x) of which conditions are defined in JIS (Japan Industrial Standard).

$$Ra = \frac{1}{L} {\int }_{0}^{L} \vert f ( x ) \vert d x \qquad [ Formula 1 ]$$

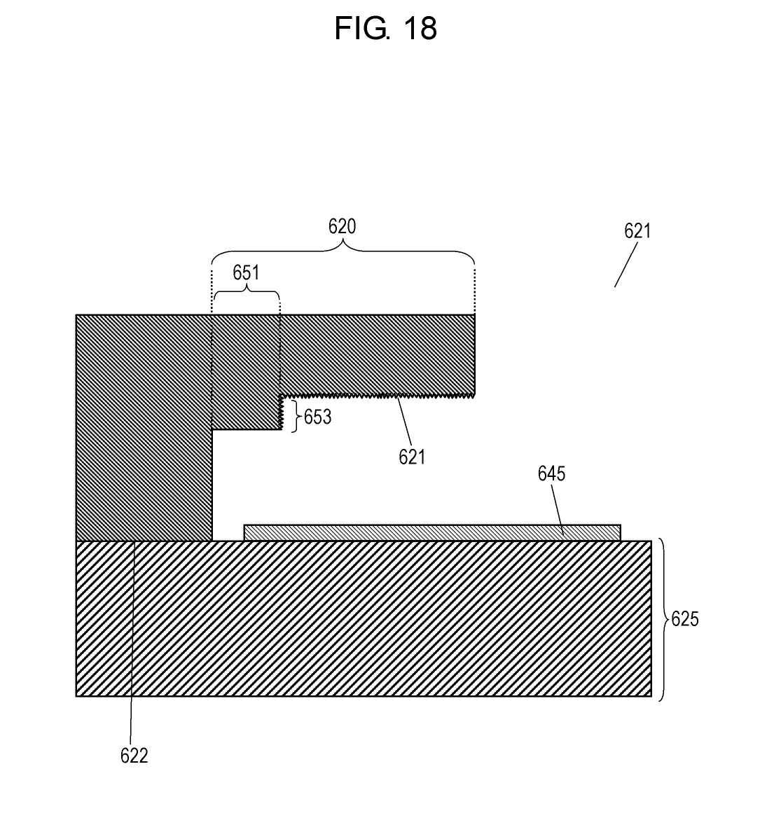

FIG. 18 is an enlarged view of sensor 600 shown in FIG. 17, and particularly illustrates roughened region 621. Surface 2603 of substrate 603 preferably includes smooth section 651 between roughened region 621 and bonding section 622. Smooth section 651 has a smoothness similar to bonding section 622 and smoother than roughened region 621. This configuration prevents the reliability of the bonding between upper lid wafer 623 and sensing element wafer 625 from lowering. When roughened region 621 is formed, mixed acid is used. The mixed acid may corrode bonding section 622 because of a positional deviation of a resist mask. Smooth section 651 prevents the mixed acid from roughing bonding section 622, preventing the reliability of the bonding between upper lid wafer 623 and sensing element wafer 625 from lowering.

Smooth section 651 preferably has a width not smaller than 5 μm. This configuration effectively prevents the mixed acid from corroding bonding section 622 caused by the positional deviation of the resist mask.

As shown in FIG. 18, upper lid wafer 623 includes roughened region 653 at a part of a side surface thereof. Region 653 is formed by etching upper lid wafer 623 during the etching process that is used for forming first roughened region 621. Roughened region 653 at a part of the side surface ensures an etching time enough for forming roughened region 621, so that the roughness of roughened region 621 can be preferably adjusted.

Surface 2603 of substrate 603 may include roughened region 643 at a place facing movable section 528. In other words, roughened region 643 is formed at a place closer to center 603c of substrate 603 than bonding section 622 that bonds substrate 603 to substrate 605. This configuration prevents movable section 528 from sticking onto substrate 603. The arithmetic average roughness Ra of roughened region 643 is not smaller than about 100 nm.

A portion of a periphery of surface 2603 of substrate 603 facing substrate 605 is roughened while a portion of surface 2603 of substrate 603 facing movable section 528 is also roughened. In other words, surface 2603 of substrate 603 preferably includes both of roughened sections 621 and 643. This structure prevents sensing element wafer 625 from damage, and also prevents movable section 528 from sticking onto substrate 603. The arithmetic average roughness Ra not smaller than about 100 nm of both of roughened regions 621 and 643 prevents sensing element wafer 625 from damage and also prevents the sticking more effectively. Roughened regions 621 and 643 can be formed in the same manufacturing process, thereby improving the productivity.

Roughened region 643 preferably has a maximum height Rmax not larger than about 1 μm. The maximum height Rmax is defined in JIS as follows: a reference length L is extracted from a rough curve in an average line direction, and an interval between a peak line and a valley line of the extracted portion is expressed in micro meters.

Substrate 603 functions as a stopper for limiting a movable range of movable section 528. Maximum height Rmax excessively larger than necessary increases the distance between substrate 603 and movable section 528, thereby increasing the movable range of movable section 528, and thus lowering the anti-shock property. Maximum height Rmax is thus preferably within a range where the anti-shock property can be established. A voltage is applied between movable section 528 and substrate 603 for lifting movable section 528 with electrostatic, attraction, so that a self-diagnosis can be performed for finding a break in the beams and whether an output is proper or not. The self-diagnostic output is proportionate to electrostatic attraction F that attracts movable section 528. Namely, Formula 2 with a voltage V applied, a surface area S of movable section 528, a distance d between substrate 603 and movable section 528, and an electrostatic attraction F is established.

$$F ∝ S \cdot {( \frac{V}{D} )}^{2} \qquad [ Formula 2 ]$$

A larger roughness of surface increases surface area A, and decreases distance d. Distance d acts by a power (a square) in Formula 2, so that a large maximum height Rmax reduces the self-diagnostic output. The maximum height Rmax is thus preferably within a range that does not reduce excessively the self-diagnostic output. To be more specific, the maximum height Rmax is preferably not larger than 1 μm.

Surface 2603 of substrate 603 preferably includes a non-roughened region between the periphery of surface 2603 facing substrate 605 and movable section 528 of surface 2603, namely between roughened region 621 and roughened region 643. The non-roughened region can be used as bonding section 622 at which the sensing element is bonded to substrate 603. The non-roughened region is not roughened, and hence, can improve the reliability of bonding between substrate 603 and substrate 605.

Metal layer 645 extending across regions A1 (see FIG. 17) where roughened region 621 overlaps substrate 605 and region A2 (see FIG. 1 where roughened region 621 does not overlap substrate 605 may be provided on surface 1605 of substrate 605. In this case, a periphery of surface 2603 of substrate 603 facing substrate 605 is roughened to form roughened region 621, thereby reducing damages on metal layer 645. Metal layer 645 may be formed on the surface of substrate 605, or inside substrate 605. Metal layer 645 inside substrate 605 is covered with an insulative layer (e.g. resin or silicon oxide film) so that metal layer 645 is not exposed from the surface of substrate 605 (sensing element) but formed inside substrate 605. Metal layer 645 is not limited to the electrical wiring, but it can form, for instance, a circuit pattern that processes electrical signals supplied from substrate 605.

Substrate 607 may include a processing circuit built therein for processing electrical signals from substrate 602 (sensing element). This structure allows substrate 605 and the processing circuit stacked together, hence reducing the size of sensor 600. Nevertheless substrate 607 is not an essential element of sensor 600, which thus not necessarily includes substrate 607.

Sensor 600 in accordance with Embodiment 2 is useful for an inertial sensor to be used in electronic devices.

In Embodiments 1 and 2, terms, such as “upper lid layer”, “lower lid layer”, “upper surface”, “lower surface”, “above”, and “below”, indicating directions merely indicate relative directions determined by relative positional relations of structural elements, such as the upper lid layer, the lower lid layer, and the sensor layer, of the sensor, and do not indicate absolute directions, such as a vertical direction.

### INDUSTRIAL APPLICABILITY

A sensor according to the present invention can reduce the size of a wafer, and is useful for a sensor to be mounted to a vehicle controller or a portable phone for sensing an acceleration.

### REFERENCE MARKS IN THE DRAWINGS

1 sensor layer
2a upper lid layer
2b lower lid layer
14c insulative region
14d outer circumferential region
14a, 24a, 34, 34b via-electrode
15, 16 projection
522 supporter
523, 524, 525, 526 beam
527, 528, 529, 530 movable section
531, 532, 533, 534, 538A, 538B sensing section
600 sensor
603 substrate
605 substrate
620 periphery
621 roughened region
622 bonding section
623 upper lid wafer
625 sensing element wafer
627 lower lid wafer
631a, 631b, 633a, 633b modified layer
643 roughened region
651 smooth section

1. A sensor comprising:
an upper lid layer;
a lower lid layer; and
a sensor layer disposed between the upper lid layer and the lower lid layer;
wherein one of the upper lid layer and the lower lid layer includes:
an insulative region mainly made of glass;
a via-electrode covered with the insulative region; and
an outer circumferential region provided at an outer circumference of the insulative region and mainly made of silicon.

2. The sensor according to claim 1, wherein the via-electrode is made of silicon.

3. The sensor according to claim 1, wherein the upper lid layer includes a projection protruding downward.

4. The sensor according to claim 1, wherein the lower lid layer includes a projection protruding upward.
